(19) United States
(12) Patent Application Publication
(10) Pub. No.: US 2022/0089898 A1
(43) Pub. Date: Mar. 24, 2022

(54) THERMOPLASTIC ELASTOMER OVERMOLD COMPOSITION

(71) Applicant: Star Thermoplastic Alloys & Rubbers, Inc., Broadview, IL (US)

(72) Inventors: Prakash SANJEEVAIAH, Orland Park, IL (US); Krishna VENKATASWAMY, Crystal Lake, IL (US); Pei-Zhen JIAN, Clarendon Hills, IL (US)

(21) Appl. No.: 17/475,885

(22) Filed: Sep. 15, 2021

Related U.S. Application Data
(60) Provisional application No. 63/080,512, filed on Sep. 18, 2020.

(51) Int. Cl. C09D 153/02; C09D 7/63; C09D 7/48; C09D 7/61; C08J 7/04

(52) U.S. Cl. CPC C09D 153/025; C09D 7/63; C09D 7/48; C09D 7/61; C08J 7/0427; C08J 2453/02; C08L 2205/025; C08L 2205/035; C08L 2207/322; C08L 2201/08; C08L 2205/06

(57) ABSTRACT

A thermoplastic elastomer composition for overmolding a plastic article or substrate, a method for the preparation of an overmolded article, and an overmolded article having a layer of thermoplastic elastomer is provided. The thermoplastic elastomer composition comprises a blend of hydrogenated styrene block copolymers and unsaturated styrene block copolymer. The method for the preparation of the overmolded article comprises applying a thermoplastic elastomer composition to at least a portion of the exterior surface of a rigid plastic substrate.

### CROSS REFERENCE TO RELATED APPLICATIONS

This is a written application for patent filed pursuant to 35 U.S.C. § 111(a). This application claims the benefit of the filing date under 35 U.S.C. § 119(e) from U.S. Provisional Patent Application Ser. No. 63/080,512, filed Sep. 18, 2020, which is hereby incorporated by reference in its entirety.

### TECHNICAL FIELD

The disclosure relates to overmold compositions and overmold layers for polymer articles, methods of preparing the overmold compositions, methods of overmolding layers on polymer articles, and polymer articles having an overmold layer of the overmold composition. The disclosure more particularly relates to thermoplastic elastomer overmold compositions and overmold layers for polymer articles, methods of preparing the thermoplastic elastomer overmold compositions, methods of overmolding layers on polymer articles, and polymer articles having an overmold layer of the thermoplastic elastomer overmold composition.

### BACKGROUND

Overmold compositions based on thermoplastic elastomers are known. Thermoplastic elastomer-based overmold compositions may be used to overmold shaped engineered plastic articles made from, for example, polyacrylates, acrylonitrile-butadiene-styrene, polybutylene terephthalate, polycarbonate, polyethylene terephthalate, polymethyl methacrylate, polyphenylene oxide, polymethylene oxide, polystyrene, styrene acrylonitrile, high impact polystyrene, polyamide (ie, nylon), polyolefins (such as polyethylene and polypropylene) and blends of these polymers.

An ongoing challenge for manufacturers of overmolded rigid plastic parts is poor adhesion of the thermoplastic elastomer-based overmold composition to the exterior surface of the underlying rigid plastic article or substrate. Poor adhesion of the overmold composition of the surface of the plastic substrate generally results in peeling, curling, fraying, or delamination of the thermoplastic elastomer overmold layer from the surface of the rigid plastic article.

The adhesion of the thermoplastic elastomer overmold layer to the underlying rigid engineering plastic article is dictated by several mechanisms, such as surface energy match between the thermoplastic elastomer overmold composition and the underlying rigid plastic article, the wetting/wettability of the soft thermoplastic elastomer overmold composition, and the interaction between the thermoplastic elastomer overmold composition and the exterior surface of the rigid plastic article. Attempts have been made in the art to match the surface energy between the thermoplastic elastomer overmold composition and the rigid plastic substrate, and to improve the wettability of the soft/flowing thermoplastic elastomer composition on the surface of the underlying rigid plastic substrate.

There is a particular need for an overmold thermoplastic elastomer compositions which adhere and remain tightly adhered to a surface of a shaped engineering plastic article, regardless of the type of engineering plastic. There is also a need to provide thermoplastic elastomer-based overmold compositions and overmold layers for engineered plastic articles having improve mechanical properties (such as, for example, tensile strength, tear strength and elongation at break) as compared to known overmold layers.

### SUMMARY

According to certain illustrative embodiments, disclosed is a thermoplastic elastomer composition for overmolding a substrate, the thermoplastic elastomer composition comprises a first hydrogenated styrene block copolymer having a first styrene content, a second hydrogenated styrene block copolymer having a second styrene content that is less than the first styrene content of the first hydrogenated styrene block copolymer, an unhydrogenated styrene block copolymer, and a plasticizer.

According to certain illustrative embodiments, also disclose is a method for the preparing an overmolded article comprising forming at least one layer of a thermoplastic elastomeric composition comprising a first hydrogenated styrene block copolymer having a first styrene content, a second hydrogenated styrene block copolymer having a second styrene content that is less than the first styrene content of the first hydrogenated styrene block copolymer, an unhydrogenated styrene block copolymer and a plasticizer on a substrate.

According to certain illustrative embodiments, the method for forming an overmolded article comprises heating a thermoplastic elastomeric composition comprising a first hydrogenated styrene block copolymer having a first styrene content, a second hydrogenated styrene block copolymer having a second styrene content that is less than the first styrene content of the first hydrogenated styrene block copolymer, an unhydrogenated styrene block copolymer and a plasticizer, and applying the heated thermoplastic elastomer composition to a substrate.

According to certain illustrative embodiments, also disclosed is a rigid plastic article having at least one layer of a thermoplastic elastomer composition thereon, the thermoplastic elastomer composition comprising a first hydrogenated styrene block copolymer having a first styrene content, a second hydrogenated styrene block copolymer having a second styrene content that is less than the first styrene content of the first hydrogenated styrene block copolymer, an unhydrogenated styrene block copolymer and a plasticizer.

According to certain illustrative embodiments, also disclosed is an overmolded article produced by the method comprising forming at least one layer of a thermoplastic elastomeric composition comprising a first hydrogenated styrene block copolymer having a first styrene content, a second hydrogenated styrene block copolymer having a second styrene content that is less than the first styrene content of the first hydrogenated styrene block copolymer, an unhydrogenated styrene block copolymer and a plasticizer on a substrate.

According to certain embodiments, disclosed is an overmolded article produced by the method comprising heating a thermoplastic elastomeric composition comprising a first hydrogenated styrene block copolymer having a first styrene content, a second hydrogenated styrene block copolymer having a second styrene content that is less than the first styrene content of the first hydrogenated styrene block copolymer, an unhydrogenated styrene block copolymer and a plasticizer, applying the heated thermoplastic elastomer composition to a substrate, and cooling the applied thermoplastic elastomer composition.

### BRIEF DESCRIPTION OF THE DRAWINGS

FIG. 1A is a graph showing the peel force extension curve for a rigid polycarbonate substrate specimen overmolded with an illustrative embodiment of the thermoplastic elastomer overmold composition having of Shore A hardness of 60, tested in accordance with ASTM D6862-11.

FIG. 1B is a graph showing the peel force extension curve for a rigid polycarbonate substrate specimen overmolded with an illustrative embodiment of the thermoplastic elastomer overmold composition having of Shore A hardness of 70, tested in accordance with ASTM D6862-11.

FIG. 1C is a graph showing the peel force extension curve for a rigid polycarbonate substrate specimen overmolded with an illustrative embodiment of the thermoplastic elastomer overmold composition having of Shore A hardness of 80, tested in accordance with ASTM D6862-11.

FIG. 2A is a graph showing the peel force extension curve for a rigid polycarbonate substrate specimen overmolded with an illustrative embodiment of a filled thermoplastic elastomer overmold composition having of Shore A hardness of 60, tested in accordance with ASTM D6862-11.

FIG. 2B is a graph showing the peel force extension curve for a rigid polycarbonate substrate specimen overmolded with an illustrative embodiment of a filled thermoplastic elastomer overmold composition having of Shore A hardness of 70, tested in accordance with ASTM D6862-11.

FIG. 2C is a graph showing the peel force extension curve for a rigid polycarbonate substrate specimen overmolded with an illustrative embodiment of a filled thermoplastic elastomer overmold composition having of Shore A hardness of 80, tested in accordance with ASTM D6862-11.

FIG. 3A is a graph showing the peel force extension curve for a rigid acrylonitrile-butadiene-styrene substrate specimen overmolded with an illustrative embodiment of the thermoplastic elastomer overmold composition having of Shore A hardness of 60, tested in accordance with ASTM D6862-11.

FIG. 3B is a graph showing the peel force extension curve for a rigid acrylonitrile-butadiene-styrene substrate specimen overmolded with an illustrative embodiment of the thermoplastic elastomer overmold composition having of Shore A hardness of 70, tested in accordance with ASTM D6862-11.

FIG. 3C is a graph showing the peel force extension curve for a rigid acrylonitrile-butadiene-styrene substrate specimen overmolded with an illustrative embodiment of the thermoplastic elastomer overmold composition having of Shore A hardness of 80, tested in accordance with ASTM D6862-11.

FIG. 4A is a graph showing the peel force extension curve for a rigid acrylonitrile-butadiene-styrene substrate specimen overmolded with an illustrative embodiment of a filled thermoplastic elastomer overmold composition having of Shore A hardness of 60, tested in accordance with ASTM D6862-11.

FIG. 4B is a graph showing the peel force extension curve for a rigid acrylonitrile-butadiene-styrene substrate specimen overmolded with an illustrative embodiment of a filled thermoplastic elastomer overmold composition having of Shore A hardness of 70, tested in accordance with ASTM D6862-11.

FIG. 4C is a graph showing the peel force extension curve for a rigid acrylonitrile-butadiene-styrene substrate specimen overmolded with an illustrative embodiment of a filled thermoplastic elastomer overmold composition having of Shore A hardness of 80, tested in accordance with ASTM D6862-11.

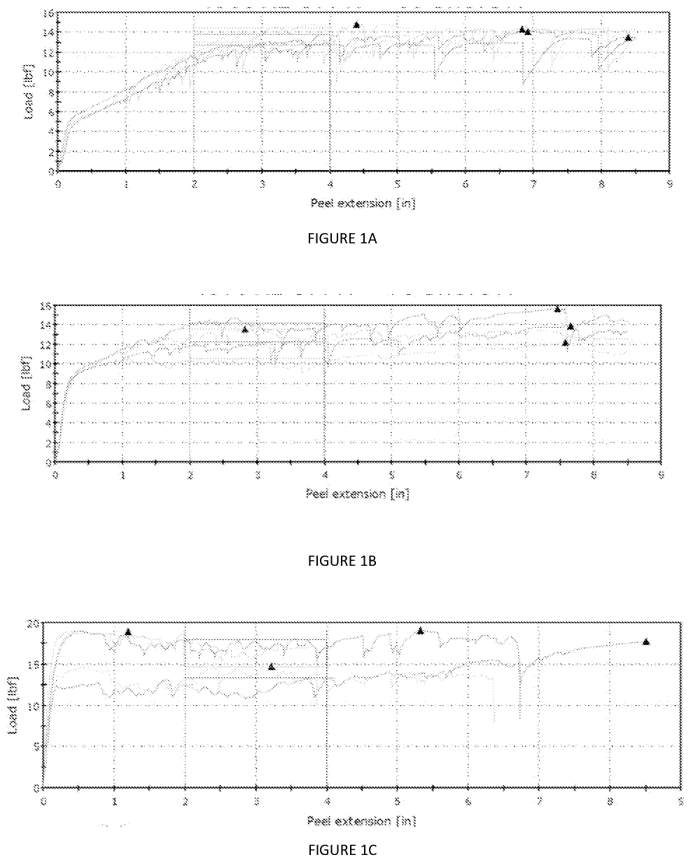

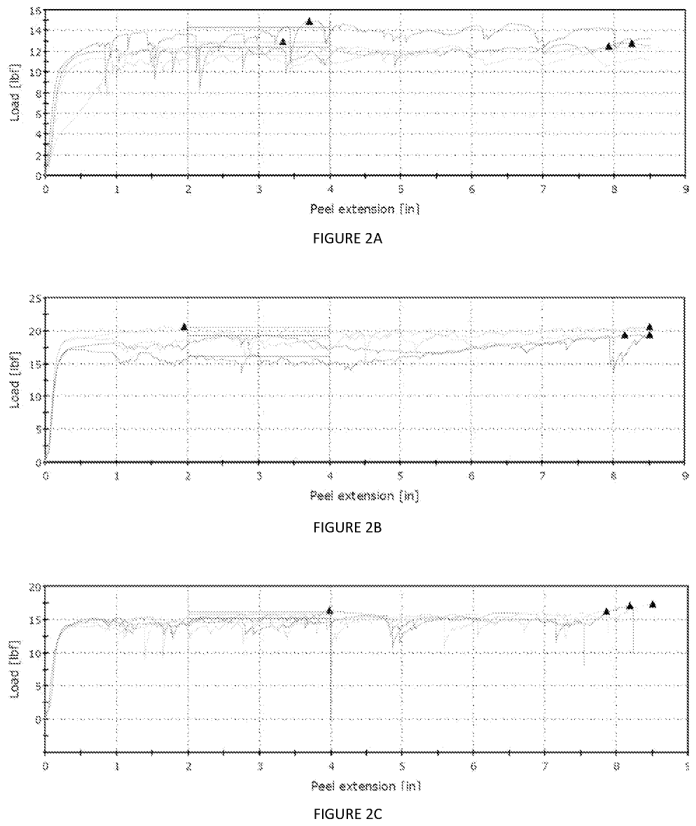

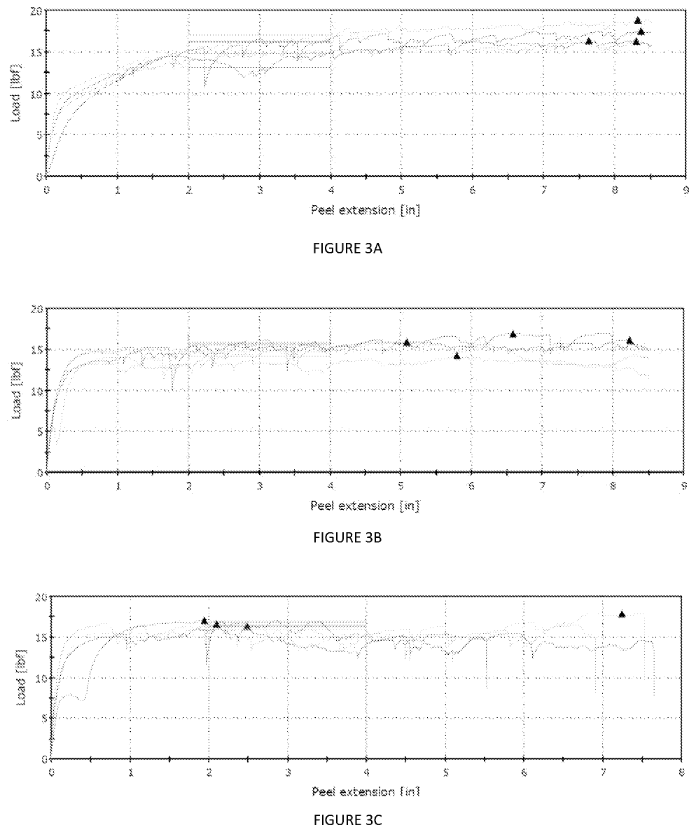

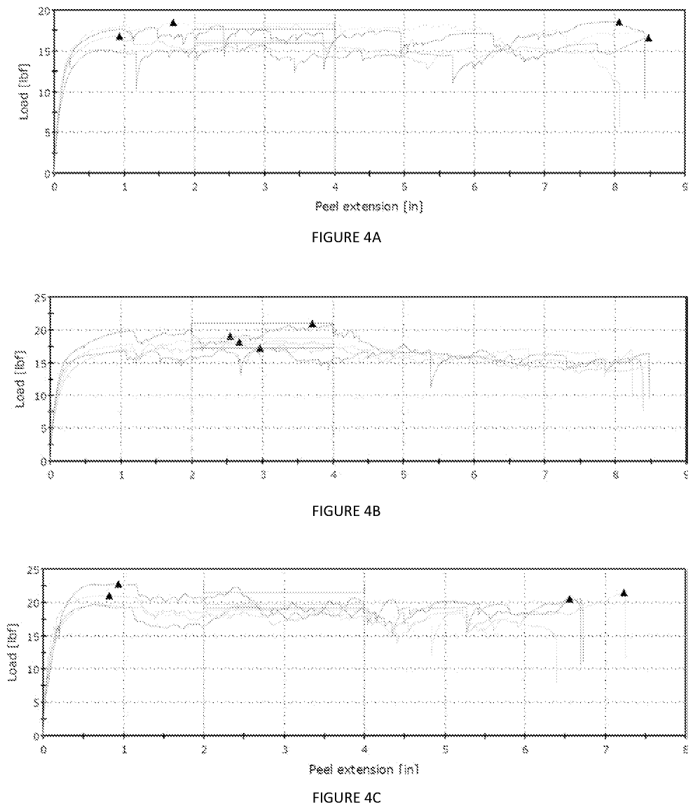

### DETAILED DESCRIPTION

The following text sets forth a broad description of numerous illustrative embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this application, which would still fall within the scope of the claims. All publications and patents cited herein are incorporated herein by reference.

Throughout the present disclosure, the use of the articles “a,” “an,” and “the” refer to one or to more than one (that is, at least one) of the grammatical object of the article. By way of example, and not in limitation, “a compound” means one compound or more than one compound.

Throughout the present disclosure, the term “about” used in connection with a value is inclusive of the stated value and has the meaning dictated by the context. For example, it includes at least the degree of error associated with the measurement of the particular value. One of ordinary skill in the art would understand the term “about” is used herein to mean that an amount of “about” of a recited value produces the desired degree of effectiveness in the compositions and/or methods of the present disclosure. One of ordinary skill in the art would further understand that the metes and bounds of “about” with respect to the value of a percentage, amount or quantity of any component in an embodiment can be determined by varying the value, determining the effectiveness of the compositions or methods for each value, and determining the range of values that produce compositions or methods with the desired degree of effectiveness in accordance with the present disclosure.

It should be understood that when a range of values is described in the present disclosure, it is intended that any and every value within the range, including the end points, is to be considered as having been disclosed. For example, “a range of from 10 percent to 100 percent” of a component, compound, composition, ingredient, reactant, etc. is to be read as indicating each and every possible number along the continuum between 10 and 100. It is to be understood that the inventors appreciate and understand that any and all values within the range are to be considered to have been specified, and that the inventors have possession of the entire range and all the values within the range.

The present disclosure is broadly directed to adhering a thermoplastic elastomer composition to a second material. According to certain illustrative embodiments, the present disclosure is directed to adhering a soft overmold composition layer or layers to the exterior surface of a rigid substrate to provide an overmolded article. According to other illustrative embodiments, the present disclosure is directed to adhering a soft thermoplastic elastomer overmold composition to the exterior surface of a rigid substrate to provide an overmolded article. According to yet other illustrative embodiments, the present disclosure is directed to adhering a soft thermoplastic elastomer overmold composition to the exterior surface of a rigid plastic substrate to provide an overmolded article. The use of the thermoplastic elastomer overmolding composition eliminates the need for adhesives or primer to bond the thermoplastic elastomer material to the surface of the rigid plastic substrate.

The thermoplastic elastomer overmold composition may used to overmold the exterior surface of a rigid plastic substrate made from acrylonitrile-butadiene-styrene (ABS), polybutylene terephthalate (PBT), polycarbonate (PC), polyethylene terephthalate (PET), polymethyl methacrylate (PMMA), polyphenylene oxide (PPO), polystyrene (PS), styrene acrylonitrile (SAN), high impact polystyrene (HIPS), polyolefins (such as polyethylene and polypropylene), thermoplastic polyurethanes (TPU), thermoplastic copolyesters, PC/ABS blends, PC/PET blends, PC/PBT blends, PPO/PS blends, other blends thereof, and the like.

The thermoplastic elastomer composition for overmolding a substrate to create an overmolded article comprises a first hydrogenated styrene block copolymer having a first styrene content, a second hydrogenated styrene block copolymer having a second styrene content that is less than the first styrene content of the first hydrogenated styrene block copolymer, an unhydrogenated styrene block copolymer and a plasticizer. According to certain embodiments, the thermoplastic elastomer composition for overmolding a substrate to create an overmolded article comprises a first hydrogenated styrene block copolymer having a first molecular weight, a second hydrogenated styrene block copolymer having a second molecular weight that is less than the first molecular weight of the first hydrogenated styrene block copolymer, an unhydrogenated styrene block copolymer and a plasticizer. According to other embodiments, the thermoplastic elastomer composition for overmolding a substrate to create an overmolded article comprises a first hydrogenated styrene block copolymer having a first styrene content and a first molecular weight, a second hydrogenated styrene block copolymer having a second styrene content that is less than the first styrene content and a second molecular weight that is less than the first molecular weight of the first hydrogenated styrene block copolymer, an unhydrogenated styrene block copolymer and a plasticizer.

According to illustrative embodiments, the hydrogenated styrene block copolymer may be selected from styrene-ethylene/butylene-styrene (SEBS) block copolymers, styrene-ethylene/propylene-styrene (SEPS) block copolymers, styrene-ethylene/ethylene/propylene-styrene (SEEPS), styrene-isobutylene-styrene (SIBS), and blends thereof.

According to certain embodiments, the first hydrogenated styrene block copolymer comprises a styrene-ethylene/butylene-styrene (SEBS) block copolymer. According to other embodiments, the second hydrogenated styrene block copolymer comprises a styrene-ethylene/butylene-styrene (SEBS) block copolymer. According to yet further embodiments, both the first and second hydrogenated styrene block copolymers comprise styrene-ethylene/butylene-styrene (SEBS) block copolymers.

According to certain embodiments, the first hydrogenated styrene block copolymer comprises a styrene-ethylene/propylene-styrene (SEPS) copolymer. According to other embodiments, the second hydrogenated styrene block copolymer comprises a styrene-ethylene-/propylene-styrene (SEPS) copolymer. According to yet further embodiments, both the first and second hydrogenated styrene block copolymers comprise styrene-ethylene/propylene-styrene (SEPS) copolymers.

According to certain embodiments, the first hydrogenated styrene block copolymer comprises a styrene-ethylene/butylene-styrene (SEBS) copolymer and the second hydrogenated styrene block copolymer comprises a styrene-ethylene/propylene-styrene (SEPS) copolymer. According to certain embodiments, the first hydrogenated styrene block copolymer comprises a styrene-ethylene/propylene-styrene (SEPS) copolymer and the second hydrogenated styrene block copolymer comprises a styrene-ethylene-buytlene/styrene (SEBS) copolymer.

According to certain embodiments, the first hydrogenated styrene block copolymer comprises a first styrene content and a first molecular weight, and the second hydrogenated styrene block copolymer comprises a second styrene content and a second molecular weight, where the second styrene content is less than the first styrene content and the second molecular weight is less that the first molecular weight. According to other embodiments, the first hydrogenated styrene block copolymer comprises a styrene-ethylene/butylene-styrene triblock copolymer having first styrene content and a first molecular weight, and the second hydrogenated styrene block copolymer comprises a styrene-ethylene/butylene-styrene triblock copolymer having a second styrene content and a second molecular weight, where the second styrene content is less than the first styrene content and the second molecular weight is less that the first molecular weight.

According to other embodiments, the first hydrogenated styrene block copolymer comprises a styrene-ethylene/butylene-styrene triblock copolymer having first styrene content of 31 weight percent or greater and a first molecular weight, and the second hydrogenated styrene block copolymer comprises a styrene-ethylene/butylene-styrene triblock copolymer having a second styrene content of less than 31 weight percent and a second molecular weight, where the second styrene content is less than the first styrene content and the second molecular weight is less that the first molecular weight.

According to other embodiments, the first hydrogenated styrene block copolymer comprises a styrene-ethylene/butylene-styrene triblock copolymer having first styrene content in the range of 31 to 35 weight percent and a first molecular weight, and the second hydrogenated styrene block copolymer comprises a styrene-ethylene/butylene-styrene triblock copolymer having a second styrene content in the range of 25 to less than 31 weight percent and a second molecular weight, where the second styrene content is less than the first styrene content and the second molecular weight is less that the first molecular weight.

According to other embodiments, the first hydrogenated styrene block copolymer comprises a styrene-ethylene/butylene-styrene triblock copolymer having first styrene content and a first molecular weight in the range of 250,000 to 300,000 g/mol, and the second hydrogenated styrene block copolymer comprises a styrene-ethylene/butylene-styrene triblock copolymer having a second styrene content and a second molecular weight in the range of 50,000 to 100,000 g/mol, where the second styrene content is less than the first styrene content and the second molecular weight is less that the first molecular weight.

According to other embodiments, the first hydrogenated styrene block copolymer comprises a styrene-ethylene/butylene-styrene triblock copolymer having first styrene content and a first molecular weight in the range of 280,000 to 300,000 g/mol, and the second hydrogenated styrene block copolymer comprises a styrene-ethylene/butylene-styrene triblock copolymer having a second styrene content and a second molecular weight in the range of 80,000 to 100,000 g/mol, where the second styrene content is less than the first styrene content and the second molecular weight is less that the first molecular weight.

The thermoplastic elastomer overmold composition also includes at least one unsaturated styrenic block copolymer. The at least one unsaturated styrenic block copolymer may comprise may include unsaturated styrenic diblock copolymers and unsaturated styrenic triblock copolymers. According to certain embodiments, the at least one unsaturated styrene block copolymer comprises at least one unsaturated styrene deblock copolymer. According to other embodiments, the at least one unsaturated styrene block copolymer comprises an unsaturated styrene triblock copolymer. Without limitation, and only by way of example, suitable unsaturated styrene triblock copolymers may be selected from styrene-isoprene-styrene (SIS) and styrene-butadiene-styrene (SBS) copolymers.

The thermoplastic elastomer overmold composition includes a suitable plasticizer. According to certain embodiments, the plasticizer may comprise a liquid plasticizer. According to other embodiments, the liquid plasticizer comprises a process oil. Process oils can be used to extend and soften the compositions disclosed herein. Without limitation, suitable process oils in aromatic oils, non-labelled aromatic oils, naphthenic oils, paraffinic oils, vegetable and bio oils not based on petroleum. Those skilled in the art will be able to select the type and suitable amount of process oil to be used. All disclosed embodiments of the thermoplastic elastomer overmold composition further include an end block modifier for the styrene blocks of at least one of the first hydrogenated styrene block copolymer, the hydrogenated second styrene block copolymer, the unsaturated styrene block copolymer and the additional polystyrene polymer. According to certain embodiments, a suitable end block modifier for the styrene blocks is Plastolyn 290.

The thermoplastic elastomer overmold compositions may further include one or more common additives for elastomer compositions. For example, and without limitation, the thermoplastic overmold compositions may include one or more of antioxidants (such as phenolic antioxidants and phosphite antioxidants), antiozonants, reinforcing and non-reinforcing fillers, fibers (like glass, carbon fibers or carbon fibrils), heat stabilizers, waxes, UV light stabilizers, cross-linking agents, processing aids, lubricants, foaming agents, flame retardant packages, flow agents, rheology modifiers, tackifying agent, pigments and other coloring agents. Those skilled in the art will be able to select the type and suitable amount of the additives based on the properties of the additive(s) and the desired properties of the composition.

Suitable fillers used in the thermoplastic elastomer compositions disclosed herein include at least one of calcium carbonate, carbon black, silica, clays, talc, titanium dioxide, metal oxides, and the like, and combinations thereof. According to certain embodiments, the thermoplastic elastomer overmold compositions disclosed herein include at least one of carbon black, silica, or combinations thereof. Those skilled in the art will be able to select the type and suitable amount of the filler(s) based on the properties of the filler(s).

According to certain illustrative embodiments, the amount of the hydrogenated styrene block copolymer present in the thermoplastic elastomer overmold composition in parts per hundred rubber (“phr”) is greater than the amount of the unsaturated styrene block copolymer present in the thermoplastic elastomer overmold composition in parts per hundred rubber (“phr”).

According to certain illustrative embodiments, the amount of the first hydrogenated styrene block copolymer present in the thermoplastic elastomer overmold composition in parts per hundred rubber (“phr”) is greater than the amount of the unsaturated styrene block copolymer present in the thermoplastic elastomer overmold composition in parts per hundred rubber (“phr”).

According to certain illustrative embodiments, the amount of the second hydrogenated styrene block copolymer present in the thermoplastic elastomer overmold composition in parts per hundred rubber (“phr”) is greater than the amount of the unsaturated styrene block copolymer present in the thermoplastic elastomer overmold composition in parts per hundred rubber (“phr”).

According to other embodiments, the combined amount of the first and second hydrogenated styrene block copolymers present in the thermoplastic elastomer overmold composition in parts per hundred rubber (“phr”) is greater than the amount of the unsaturated styrene block copolymer present in the thermoplastic elastomer overmold composition in parts per hundred rubber (“phr”).

According to other embodiments, the combined amount of the first and second hydrogenated styrene block copolymers present in the thermoplastic elastomer overmold composition is 35, 40, 45, 50, 55, 60, 65, 70, 75, 80, 85, 90, 95, or 100 parts per hundred rubber (“phr”), and is present in an amount that is greater than the amount of the unsaturated styrene block copolymer present in the thermoplastic elastomer overmold composition in parts per hundred rubber (“phr”).

According to other embodiments, the combined amount of the first and second hydrogenated styrene block copolymers present in the thermoplastic elastomer overmold composition is 35 parts per hundred rubber (“phr”) or greater, and the unsaturated styrene block copolymer present in the thermoplastic elastomer overmold composition in an amount of less than 35 parts per hundred rubber (“phr”) or less. The combined amount of the first and second hydrogenated styrene block copolymers present in the thermoplastic elastomer overmold composition may be 35, 40, 45, 50, 55, 60, 65, 70, 75, 80, 85, 90, 95, or 100 parts per hundred rubber (“phr”), and the unsaturated styrene block copolymer present in the thermoplastic elastomer overmold composition in an amount of less than 35 parts per hundred rubber (“phr”) or less.

According to certain illustrative embodiments, the thermoplastic elastomer overmold composition comprises a combined amount of the first and second hydrogenated styrene block copolymers in parts per hundred rubber (“phr”), an amount the unsaturated styrene block copolymer in parts per hundred rubber (“phr”) that is less than the combined amount of the first and second hydrogenated styrene block copolymers, and additional polystyrene. According to certain embodiments, the additional polystyrene is present in amount that is less than the combined amount of the first and second hydrogenated styrene block copolymers and less than the amount of the unsaturated styrene block copolymer.

According to certain illustrative embodiments, the thermoplastic elastomer overmold composition comprises a combined amount of the first and second hydrogenated styrene block copolymers in parts per hundred rubber (“phr”), an amount the unsaturated styrene block copolymer in parts per hundred rubber (“phr”) that is less than the combined amount of the first and second hydrogenated styrene block copolymers, and an amount of additional polystyrene that is less than the individual amounts of each of the first and second hydrogenated styrene block copolymers and less than the amount of the unsaturated styrene block copolymer.

According to other embodiments, the thermoplastic elastomer overmold composition includes a combined amount of the first and second hydrogenated styrene block copolymers of 35 parts per hundred rubber (“phr”) or greater, less than 35 parts per hundred rubber (“phr”) of the unsaturated styrene block copolymer, and 20 parts per hundred rubber or less of additional polystyrene polymer where the amount of the additional polystyrene is less than the combined amount of the first and second hydrogenated styrene block copolymers and less than the amount of the unsaturated styrene block copolymer. According to other embodiments, the thermoplastic elastomer overmold composition includes a combined amount of the first and second hydrogenated styrene block copolymers of 35, 40, 45, 50, 55, 60, 65, 70, 75, 80, 85, 90, 95, or 100 parts per hundred rubber (“phr”), 30 parts per hundred rubber (“phr”) or less of the unsaturated styrene block copolymer, and 20 parts per hundred rubber of additional polystyrene polymer.

The various illustrative embodiments of the provided thermoplastic elastomer overmold compositions disclosed herein provide abrasion resistance to the overmolded rigid plastic substrate.

The various illustrative embodiments of the provided thermoplastic elastomer overmold compositions disclosed herein provide chemical resistance to the overmolded rigid plastic substrate.

The various illustrative embodiments of the provided thermoplastic elastomer overmold compositions disclosed herein provide water resistance to the overmolded rigid plastic substrate.

The various illustrative embodiments of the provided thermoplastic elastomer overmold compositions disclosed herein provide electrical insulation to the overmolded rigid plastic substrate.

The various illustrative embodiments of the provided thermoplastic elastomer overmold compositions disclosed herein provide acoustic insulation/sound absorption to the overmolded rigid plastic substrate.

The various illustrative embodiments of the provided thermoplastic elastomer overmold compositions disclosed herein provide impact resistance to the overmolded rigid plastic substrate.

The various illustrative embodiments of the provided thermoplastic elastomer overmold compositions disclosed herein provide vibration resistance to the overmolded rigid plastic substrate.

The various illustrative embodiments of the provided thermoplastic elastomer overmold compositions disclosed herein provide high adhesion to the overmolded rigid plastic substrate.

The various illustrative embodiments of the provided thermoplastic elastomer overmold compositions disclosed herein provide high peel strength to the overmolded rigid plastic substrate.

The various illustrative embodiments of the provided thermoplastic elastomer overmold compositions disclosed herein provide high tear strength to the overmolded rigid plastic substrate.

The various illustrative embodiments of the provided thermoplastic elastomer overmold compositions disclosed herein provide soft feel and improved gripping of the overmolded rigid plastic substrate.

A method for preparing an overmolded rigid plastic article is provided. The method for the preparation of an overmolded article comprises adhering a thermoplastic elastomer composition to the exterior surface a rigid plastic substrate, the thermoplastic elastomer composition comprising a first hydrogenated styrene block copolymer having a first styrene content, a second hydrogenated styrene block copolymer having a second styrene content that is less than the first styrene content of the first hydrogenated styrene block copolymer, an unhydrogenated styrene block copolymer, and a plasticizer.

According to certain illustrative embodiments of the two-shot injection process, a rigid plastic part is molded in the first shot and the thermoplastic elastomer composition is molded over a portion of the molded plastic part in the second shot.

According to other illustrative embodiments of the two-shot injection process, a rigid plastic part is molded and the thermoplastic elastomeric composition is molded over a portion of the molded plastic part using a two-shot injection molding machine with suitable mold that could perform the two shot operation.

According to other illustrative embodiments, a rigid plastic part and the thermoplastic elastomeric overmold composition may be bonded together via a welding operation initiated by heat, infra-red radiation, or ultraviolet energy.

### EXAMPLES

The following examples are given solely for the purpose of illustration and are not to be construed as limitations of the present disclosure, as many variations of the invention are possible without departing from the spirit and scope of the present disclosure.

The following test methods were used to measure the physical properties of the inventive thermoplastic elastomer overmold compositions:

Shore A hardness testing performed in accordance with ASTM D2240,

Specific gravity measurements performed in accordance with ASTM D792,

Capillary rheology testing protocol performed in accordance with ASTM D3835,

Tensile testing including Stress at Break, Modulus, Elongation at Break, Tensile Strength performed in accordance with ASTM D412A,

Tear Strength testing protocol performed in accordance with ASTM D624,

90° Peel Strength testing protocol performed in accordance with ASTM D6862.

Sample Preparation: Each of the different formulations was compounded on the twin screw extruder and pelletized. Pellet samples were used made standard plaques having the dimensions of 2″×4″×0.125″ thickness. These plaques were kept at room temperature for 24 hours and were then used to perform various physical tests.

Shore A Hardness test: 5 pairs of plaques were used for test. Each pair were stacked together to create 0.250″ thickness and kept on a uniform and stable bench top. Using Shore A durometer, 10 sec hardness measurement were taken at 3 points with each pair at 10 sec delay following the ASTM D2240 test method. Readings were recorded and average of 15 datapoints were reported as Shore A Hardness for the sample. The thermoplastic elastomeric composition may have a Shore A hardness in the range of about 60 to about 80, about 60 to about 75, about 60 to about 70, about 60 to about 65, about 65 to about 80, about 65 to about 75, about 65 to about 70, about 70 to about 80, or about 75 to about 80.

Specific gravity test: A small portion of about ½ inch size is cut from the molded plaque and tested for specific gravity following the ASTM D792 test method.

Capillary rheology test: One molded plaque is cut into slices lengthwise and packed into a capillary rheometer barrel maintained at a temperature of about 210° C. Rheology is recorded at 10 different shear rates and is reported as such. The ASTM D3835 method was used for this test. The thermoplastic elastomeric composition exhibited a rheology at 210C as measured in accordance with ASTM D3835 of about 10 to about 20 Pa*s, from about 10 to about 15 Pa*s, from about 10 to about 14 Pa*s, from about 10 to about 13 Pa*s, about 10 to about 12 Pa*s, from about 10 to about 11 Pa*s, from about 11 to about 15 Pa*s, about 11 to about 14 Pa*s, about 11 to about 13 Pa*S, about 11 to about 12 Pa*s, from about 12 to about 15 Pa*s, about 12 to about 14 Pa*s, about 12 to about 13 Pa*S, from about 13 to about 15 Pa*s, or about 13 to about 14 Pa*s.

Tensile test: Molded plaques are used for this test. Plaques were cut into test specimen using Die C in accordance with the ASTM protocol. The test specimen was held between two grips of tensile testing machine. The measurement is started when the specimen is stretched lengthwise until it breaks. The instrument records modulus at various stretch (elongation) levels, tensile at break, elongation and tabulates it. 5 specimens are run using same setup to achieve average of the results and reported as such in accordance with ASTM D412A.

Tear strength test: molded plaques are used for this test. Plaques are cut into test specimen using Die of the ASTM protocol. The test specimen was held between two grips of tear testing machine. The measurement is started when the specimen is stretched lengthwise until it breaks. The instrument records the 90° tear strength in pli. 3 test specimens are used to achieve multiple data and average is reported as such following ASTM D624. The thermoplastic elastomeric composition exhibited a Tear Strength (pli) of 375 pli or greater, or 400 pli or greater, 450 pli or greater, 500 pli or greater, or 350 to 450 pli or greater, or 400 to 500 pli or greater. Unfilled embodiments of the thermoplastic elastomeric composition exhibited a Tensile Strength (psi) of 1,000 psi or greater, 1,100 psi or greater, 1,200 psi or greater, 1,300 psi or greater, 1,400 psi or greater, or 1,500 psi or greater. Filled embodiments of the thermoplastic elastomeric composition exhibited a Tensile Strength (pli) of 600 to 900 psi, or 600 to 800 pdi, or 600 to 700 psi, or 700 to 900 psi, or 700 to 800 psi, or 800 to 900 psi.

Peel strength test: Pellets samples of each formulation were overmolded onto commercially available substrate strips of polycarbonate and ABS resin of certain thickness. These bonded strips of 1-inch width and 4 inch long 5 specimens were subjected to 90° peel test following ASTM D6862 using tensile tester with attached peel test fixture. The measurement is started when the tensile grip starts peeling the overmolded resin from the substrate. The peel strength is measured as the force that is required in pli to peel the overmolded resin from the substrate. The maximum force is recorded in average of 5 test specimens.

The following components were used to prepare the sample formulations of the thermoplastic elastomer overmold composition:

Taipol 6150 (aka Taipol SEBS-6150) is a linear, medium molecular weight styrene ethylene/butylene styrene (SEBS) block copolymer commercially available from TSRC Corporation (Taiwan).

Taipol 6151 (aka Taipol SEBS-6151) is a linear, high molecular weight styrene ethylene butylene styrene (SEBS) block copolymer commercially available from TSRC Corporation (Taiwan).

Nyflex 223 is a naphthenic process oil commercially available from Nynas USA Inc. (Houston, Tex., USA).

Styroflex 2G66 is a styrene-butadiene block copolymer commercially available from INEOS Styrolution America LLC (Aurora, Ill., USA).

Plastolyn 290 is a flow modifier commercially available from Eastman Chemical Company (USA).

Irgafos® 168 is a phosphite antioxidant and heat stabilizer available from BASF.

Irganox® 1010 is a phenolic primary antioxidant and heat stabilizer commercially available from BASF.

Vicron® 25-11 is a limestone and quartz mineral filler commercially available from Specialty Minerals, Inc. (Bethlehem, Pa., USA).

The amounts of each of the components of the thermoplastic elastomeric overmold compositions set forth in the Tables below in “phr”. The term “phr” means. As used herein, the term “phr” means parts per one hundred parts rubber.

Table 1 below shows the formulations and measured properties for three illustrative embodiments (Examples 1-3) of the thermoplastic elastomer overmold composition.

TABLE 1

| Example | 1 | 2 | 3 |
|---|---|---|---|
| Taipol 6151 | 60 | 60 | 60 |
| Taipol 6150 | 40 | 40 | 40 |
| Nyflex 223 | 100 | 100 | 100 |
| Styroflex 2G66 | 30 | 30 | 30 |
| Plastolyn 290 | 40 | 40 | 40 |
| Irganox 1010 | 0.25 | 0.25 | 0.25 |
| Irgafos 168 | 0.25 | 0.25 | 0.25 |
| PS 118 Polystyrene | — | 20 | 40 |
| Hardness [Shore A]: | 60 | 69 | 79 |
| Specific Gravity [g/cm³]: | 0.921 | 0.925 | 0.932 |
| Tensile Strength, psi | 1,528 | 1,372 | 1.143 |
| 300% Modulus, psi | 332 | 433 | 584 |
| Elongation, % | 824 | 763 | 668 |
| Tear strength, pli | 498 | 470 | 541 |
| Rheology (@210° C.) [Pa*s]: | 11.7 | 12.4 | 12.8 |

Overmolding process at 240° C., cooling time = 30 seconds

| | | | |
|---|---|---|---|
| Peel strength on PC, pli | 13.9 | 13 | 15.8 |
| Peel strength on ABS, pli | 15.8 | 15.5 | 17 |
| Color | Natural | Natural | Natural |
| Clarity | Opaque | Opaque | Opaque |

Table 2 below shows the formulations and measured properties for three illustrative embodiments (Examples 4-6) of the filled and natural-colored thermoplastic elastomer overmold composition.

TABLE 2

| Example | 4 | 5 | 6 |
|---|---|---|---|
| Taipol 6151 | 60 | 60 | 60 |
| Taipol 6150 | 40 | 40 | 40 |
| Nyflex 223 | 105 | 105 | 105 |
| Styroflex 2G66 | 30 | 30 | 30 |
| Plastolyn 290 | 40 | 40 | 40 |
| Irganox 1010 | 0.25 | 0.25 | 0.25 |
| Irgafos 168 | 0.25 | 0.25 | 0.25 |
| Vicron 25-11 | 80 | 80 | 80 |
| PS 118 Polystyrene | — | 20 | 40 |
| Hardness [Shore A]: | 59 | 70 | 79 |
| Specific Gravity [g/cm³]: | 1.080 | 1.073 | 1.069 |
| Tensile Strength, psi | 668 | 838 | 803 |
| 300% Modulus, psi | 451 | 527 | 587 |
| Elongation, % | 443 | 578 | 572 |
| Tear strength, pli | 414 | 458 | 509 |
| Rheology (@210° C.) [Pa*s]: | 14.2 | 12.5 | 13.8 |

Overmolding process at 240° C., cooling time = 30 seconds

| | | | |
|---|---|---|---|
| Peel strength on PC, pli | 13.9 | 19.3 | 15.8 |
| Peel strength on ABS, pli | 15.8 | 19.3 | 20.4 |
| Color | Natural | Natural | Natural |
| Clarity | Opaque | Opaque | Opaque |

Table 3 below shows the formulations and measured properties for three illustrative embodiments (Examples 7-9) of the filled and black-colored thermoplastic elastomer overmold composition.

TABLE 3

| Example | 7 | 8 | 9 |
|---|---|---|---|
| Taipol 6151 | 60 | 60 | 60 |
| Taipol 6150 | 40 | 40 | 40 |
| Nyflex 223 | 105 | 105 | 105 |
| Styroflex 2G66 | 30 | 30 | 30 |
| Plastolyn 290 | 40 | 40 | 40 |
| Irganox 1010 | 0.25 | 0.25 | 0.25 |
| Irgafos 168 | 0.25 | 0.25 | 0.25 |
| Vicron 25-11 | 80 | 80 | 80 |
| PS 118 Polystyrene | — | 20 | 40 |
| PP 535 Black | 7.25 | 7.66 | 8.07 |
| Hardness [Shore A]: | 60 | 70 | 80 |
| Specific Gravity [g/cm³]: | 1.094 | 1.070 | 1.065 |
| Tensile Strength, psi | 723 | 883 | 890 |
| 300% Modulus, psi | 416 | 478 | 657 |
| Elongation, % | 592 | 628 | 513 |
| Tear strength, pli | 376 | 450 | 536 |
| Rheology (@210° C.) [Pa*s]: | 13.2 | 14 | 15 |

Overmolding process at 240° C., cooling time = 30 seconds

| | | | |
|---|---|---|---|
| Peel strength on PC, pli | 10.5 | 11.5 | 13.7 |
| Peel strength on ABS, pli | 11.3 | 14 | 14.1 |
| Color | Black | Black | Black |
| Clarity | — | — | — |

Table 4 below shows the properties of inventive example 1, which is an unfilled, natural-colored thermoplastic elastomer overmold composition having a Shore A Hardness of 60 vs. comparative examples.

TABLE 4

| Example | 1 | C10 | C11 | C12 |
|---|---|---|---|---|
| Hardness [Shore A]: | 60 | 63 | 60 | 59 |
| Specific Gravity [g/cm³]: | 0.921 | 0.930 | 0.930 | 0.960 |
| Tensile Strength, psi | 1,528 | 753 | 595 | 943 |
| 300% Modulus, psi | 332 | 682 | 470 | — |
| Elongation, % | 824 | 330 | 490 | 600 |
| Tear strength, pli | 498 | 146 | 150 | 66 |
| Peel strength on PC, pli | 13.9 | — | 11.3 | — |
| Peel strength on ABS, pli | 15.8 | — | 10.7 | — |

Table 5 below shows the properties of inventive example 5, which is a filled, natural-colored thermoplastic elastomer overmold composition having a Shore A Hardness of 70 vs. comparative examples.

TABLE 5

| Example | 5 | C13 | C14 | C15 |
|---|---|---|---|---|
| Hardness [Shore A]: | 70 | 65 | 65 | 68 |
| Specific Gravity [g/cm³]: | 1.073 | 1.000 | 1.180 | 1.100 |
| Tensile Strength, psi | 828 | 900 | 850 | 725 |
| 300% Modulus, psi | 527 | 580 | — | — |
| Elongation, % | 578 | 600 | 680 | 500 |
| Tear strength, pli | 458 | 175 | | 91 |
| Peel strength on PC, pli | 19.3 | — | — | 31.4 |
| Peel strength on ABS, pli | 19.3 | — | — | 37.1 |

Table 6 below shows the properties of inventive example 6, which is a filled, natural-colored thermoplastic elastomer overmold composition having a Shore A Hardness of 80 vs. comparative examples.

TABLE 6

| Example | 6 | C16 |
|---|---|---|
| Hardness [Shore A]: | 79 | 77 |
| Specific Gravity [g/cm³]: | 1.069 | 1.100 |
| Tensile Strength, psi | 803 | 798 |
| 300% Modulus, psi | 587 | — |
| Elongation, % | 572 | 400 |
| Tear strength, pli | 509 | 97 |
| Peel strength on PC, pli | 15.8 | 45.7 |
| Peel strength on ABS, pli | 20.4 | 34.3 |

While the thermoplastic elastomer composition for overmolding a substrate, the method for the preparation of an overmolded article, and the overmolded article having a layer of thermoplastic elastomer have been described in connection with various illustrative embodiments, it will be understood that the embodiments described herein are merely exemplary, and that one skilled in the art may make variations and modifications without departing from the spirit and scope of the embodiments. All such variations and modifications are intended to be included within the scope of the embodiments as described hereinabove. Further, all embodiments disclosed are not necessarily in the alternative, as various embodiments may be combined to provide the desired result. Therefore, the thermoplastic elastomer composition for overmolding a substrate, the method for the preparation of an overmolded article, and the overmolded article having a layer of thermoplastic elastomer shall not be limited to any single embodiment, but rather construed in breadth and scope in accordance with the recitation of the appended claims.

1. A thermoplastic elastomer composition for overmolding a substrate comprising:
a first hydrogenated styrene block copolymer having a first styrene content;
a second hydrogenated styrene block copolymer having a second styrene content that is less than the first styrene content of the first hydrogenated styrene block copolymer;
an unhydrogenated styrene block copolymer; and
a plasticizer.

2. The thermoplastic elastomer composition for overmolding a substrate of claim 1, wherein the molecular weight of the second hydrogenated styrene block copolymer is less than the molecular weight of the first hydrogenated styrene block copolymer.

3. The thermoplastic elastomer composition for overmolding a substrate of claim 2, wherein the first and second hydrogenated styrene block copolymers are independently selected from styrene-ethylene/butylene-styrene (SEBS) block copolymers, styrene-ethylene/propylene-styrene (SEPS) block copolymers, styrene-ethylene/ethylene/propylene-styrene (SEEPS), styrene-isobutylene-styrene (SIBS), and blends thereof.

4. The thermoplastic elastomer composition for overmolding a substrate of claim 3, wherein the first hydrogenated styrene block copolymer is styrene ethylene/butylene styrene (SEBS) block copolymer.

5. The thermoplastic elastomer composition for overmolding a substrate of claim 4, wherein the second hydrogenated styrene block copolymer is styrene ethylene/butylene styrene (SEBS) block copolymer.

6. The thermoplastic elastomer composition for overmolding a substrate of claim 5, wherein the unsaturated styrene block copolymer comprises an unsaturated styrene triblock copolymer.

7. The thermoplastic elastomer composition for overmolding a substrate of claim 6, wherein the unsaturated styrene triblock copolymer is selected from styrene-isoprene-styrene (SIS) and styrene-butadiene-styrene (SBS) copolymers.

8. The thermoplastic elastomer composition for overmolding a substrate of claim 7, wherein the unsaturated styrene triblock copolymer is styrene-butadiene-styrene (SBS) copolymers.

9. The thermoplastic elastomer composition for overmolding a substrate of claim 8 further comprising a liquid plasticizer.

10. The thermoplastic elastomer composition for overmolding a substrate of claim 9, wherein the liquid plasticizer comprises a process oil.

11. The thermoplastic elastomer composition for overmolding a substrate of claim 10, wherein the process oil is selected from aromatic oils, naphthenic oils, paraffinic oils, vegetable and bio oils not based on petroleum.

12. The thermoplastic elastomer composition for overmolding a substrate of claim 11, wherein the process oil is naphthenic oil.

13. The thermoplastic elastomer composition for overmolding a substrate of claim 12, further comprising an antioxidant.

14. The thermoplastic elastomer composition for overmolding a substrate of claim 13, wherein the antioxidant is selected from phenolic antioxidants and phosphite antioxidants.

15. The thermoplastic elastomer composition for overmolding a substrate of claim 14, further comprising at least one filler.

16. The thermoplastic elastomer composition for overmolding a substrate of claim 15, wherein the filler is selected from at least one of calcium carbonate, carbon black, silica, clays, talc, titanium dioxide, metal oxides, and combinations thereof.

17. The thermoplastic elastomer composition for overmolding a substrate of claim 16, further comprising at least one additive selected from antiozonants, fibers, heat stabilizers, waxes, UV light stabilizers, cross-linking agents, processing aids, lubricants, foaming agents, flame retardants, flow agents, rheology modifiers, tackifying agent, pigments, and coloring agents.

18. The thermoplastic elastomer composition for overmolding a substrate of claim 11, wherein the substrate is a rigid plastic substrate.

19. The thermoplastic elastomer composition for overmolding a substrate of claim 18, wherein the rigid plastic substrate is selected from acrylonitrile-butadiene-styrene (ABS), polybutylene terephthalate (PBT), polycarbonate (PC), polyethylene terephthalate (PET), polymethyl methacrylate (PMMA), polyphenylene oxide (PPO), polystyrene (PS), styrene acrylonitrile (SAN), high impact polystyrene (HIPS), polyolefins (such as polyethylene and polypropylene), thermoplastic polyurethanes (TPU), thermoplastic copolyesters, PC/ABS blends, PC/PET blends, PC/PBT blends, PPO/PS blends, and other blends thereof.

20. The thermoplastic elastomer composition for overmolding a substrate of claim 1 having a Shore A Hardness of 60 to 80 as determined in accordance with ASTM D2240.

21. The thermoplastic elastomer composition for overmolding a substrate of claim 1 having Tensile Strength of at least 1000 psi as determined in accordance with ASTM D412A.

22. The thermoplastic elastomer composition for overmolding a substrate of claim 1 having Tensile Strength of at least 1100 psi as determined in accordance with ASTM D412A.

23. The thermoplastic elastomer composition for overmolding a substrate of claim 1 having Tensile Strength of at least 1200 psi as determined in accordance with ASTM D412A.

24. The thermoplastic elastomer composition for overmolding a substrate of claim 1 having Tensile Strength of at least 1300 psi as determined in accordance with ASTM D412A.

25. The thermoplastic elastomer composition for overmolding a substrate of claim 1 having Tensile Strength of at least 1400 psi as determined in accordance with ASTM D412A.

26. The thermoplastic elastomer composition for overmolding a substrate of claim 1 having Tensile Strength of at least 1500 psi as determined in accordance with ASTM D412A.

27. The thermoplastic elastomer composition for overmolding a substrate of claim 1 having Tear Strength of at least 350 pli as determined in accordance with ASTM D624.

28. The thermoplastic elastomer composition for overmolding a substrate of claim 1 having Tear Strength of at least 400 pli as determined in accordance with ASTM D624.

29. The thermoplastic elastomer composition for overmolding a substrate of claim 1 having Tear Strength of at least 450 pli as determined in accordance with ASTM D624.

30. The thermoplastic elastomer composition for overmolding a substrate of claim 1 having Tear Strength of at least 500 pli as determined in accordance with ASTM D624.

31. A method for the preparation of an overmolded article comprising applying the thermoplastic elastomer composition of claim 1 to exterior surfaces of a rigid plastic substrate.

32. An overmolded article having at least one layer of the thermoplastic elastomer composition of claim 1 overmolded to at least a portion of the exterior surface of the article.

33. An overmolded article prepared by the method of claim 31.
